(19) United States
(12) Patent Application Publication
(10) Pub. No.: US 2002/0106240 A1
(43) Pub. Date: Aug. 8, 2002

(54) Furniture joint

(76) Inventor: Raymond D. Johnson JR., Ellijay, GA (US)

Correspondence Address: Joseph G. Mitchell, ESQ., 4521 Derby Lane, Smyrna, GA, 30082, US

(21) Appl. No.: 09/777,058

(22) Filed: Feb. 5, 2001

(51) Int. Cl. F16B 1/00; F16D 1/00; B25G 3/08

(52) U.S. Cl. 403/381

(57) ABSTRACT

The invention of this patent is a furniture joint. The invention provides a single sided dovetail board that has a flat surface and an angled surface. The invention also includes a flat board, and a receiving furniture member having a slot therein. The slot in said receiving furniture member has a flat portion and angled portion. The flat board and single sided dovetail board are placed within said slot of the receiving furniture member creating a strong connection. The furniture joint can then be easily put together and taken apart. The invention can further include a dowel placed in a hole in the flat board and single sided dovetail board to create an even stronger connection.

### BACKGROUND OF THE INVENTION

1) Field of the Invention

The field of invention relates to a furniture joint. More particularly, the invention provides for a single sided dovetail board, and a flat board which fit into a receiving furniture member. The receiving furniture member has a corresponding angle that allows the single sided dovetail board to slide into said angle of the receiving furniture member, and the flat board fits into the receiving furniture member at the opposite end of the angle of the receiving furniture member. A dowel can hold the single sided dovetail board and flat board into place if required.

2) Description of Prior Art

In the prior art, there are several methods that inventors have employed to connect furniture parts together.

For example, in U.S. Pat. No. 5,664,899, bolts extend through the leg of the furniture, and further, cement is used to insure a permanent connection. In U.S. Pat. No. 4,893,958, a rod is fit into a bushing with either epoxy or an octagonal rod fitting in a square hole causing the tight or firm connection. In U.S. Pat. No. 4,274,756, concave and convex recesses attach to one another to create a fixed furniture joint.

In the prior art, a sliding dovetail furniture joints, with an angle edge on both sides, have been used in the furniture making industry for several years. But this type furniture joint is difficult to use because the long pieces of wood, either with the grain or across the grain, are hardly ever exactly straight. There is almost always a slight bow or bend in the solid pieces of wood. Usually, in putting together the furniture parts, these type furniture joints have to be hammered into place and are extremely difficult, if not impossible, to take apart without damaging the wood. Additionally, in putting together furniture with these type of furniture joints, one has to put together the furniture parts by sliding one piece into another piece only along the length of the joint. In this way, it is possible to take the joint apart in only one direction, which is usually very difficult.

In the prior art, then, there exist several methods to connect furniture pieces together. But, with the prior art, there are problems that exist with assembling and disassembling the furniture parts. The prior art furniture connections are difficult to assemble and disassemble as compared to the present invention. Also, there exists a much higher probability of breaking a furniture part with the prior art, as opposed to the present invention during assembly and disassembly. The prior art, in many instances, provides for a strong and firm connection, and likewise, the present invention provides for a strong and firm connection of furniture parts. It is a disadvantage in the known prior art for the expansion and contraction of wood used in a furniture joint, but the present invention overcomes such disadvantage because, when used with wood, the present invention allows for contracting and expanding of the wood, either across or with the grain of the wood.

### SUMMARY OF THE INVENTION

In view of the foregoing disadvantages inherent in the known prior art, the present invention provides a single sided dovetail board, a flat board and a receiving furniture member. These furniture parts, when connected, create a strong, fit, and tight furniture connection that is easy to assemble and disassemble. Additionally, a dowel can be placed in a hole drilled in the single sided dovetail board and flat board and placed within said holes to create a stronger connection. As such, the general purpose of the present invention, which will be described subsequently in greater detail, is to provide a new and improved furniture joint which has all the advantages of the prior art and none of the disadvantages.

To attain this, the present invention provides a single sided dovetail board. The single sided dovetail board has an angled edge on only one side, as opposed to a sliding dovetail joint that has an angled edge on both sides. The other side of the single sided dovetail board is flat. The present invention also provides a receiving furniture member. The receiving furniture member has a slot that has a corresponding angle, to that of the single sided dovetail board, in one portion of said slot of the receiving furniture member. The slot of the receiving furniture member has a straight portion opposite said corresponding angle of said slot in the receiving furniture member. The angled edge of said single sided dovetail board fits into the corresponding angle of the slot of the receiving furniture member. The single sided dovetail board does not fill the entire slot of the receiving furniture member. The present invention provides for a flat board. The flat board is placed in the open area of the slot of the receiving furniture member. The flat board, along with the single sided dovetail board, fills the slot of the receiving furniture member. This creates a strong connection that is easy to assemble and disassemble. Further, another embodiment of the invention is to add a dowel that can fit in a hole drilled into the single sided dovetail board and flat board to create an even stronger connection.

The invention resides not in any one of these features per se, but rather in the particular combination of all of them herein disclosed and claimed, and it is distinguished from the prior art in this particular combination of all its structures for the functions specified.

There has thus been outlined, rather broadly, the important features of the invention in order that the detailed description thereof that follows may be better understood, and in order that the present contribution to the art may be better appreciated. There are, of course, additional features of the invention that will be described hereinafter and which will form the subject matter of the claims appended hereto. Those skilled in the art will appreciate that the conception, upon which this disclosure is based, may readily be utilized as a basis for designing of other structures, methods and systems for carrying out the several purposes of the present invention. It is important, therefore, that the claims be regarded as including such equivalent constructions insofar as they do not depart from the spirit and scope of the present invention.

Further, the purpose of the foregoing abstract is to enable the U.S. Patent and Trademark Office and the public generally, and especially the scientists, engineers and practitioners in the art who are familiar with patent or legal terms or phraseology, to determine quickly from a cursory inspection the nature and essence of the technical disclosure of the application. The abstract is neither intended to define the invention of the application, which is measured by the claims, nor is it intended to be limiting as to the scope of the invention in any way.

It is therefore an object of the present invention to provide a new and improved furniture joint which has all of the advantages of the prior art and none of the disadvantages.

It is another object of the present invention to provide a new and improved furniture joint which may be easily assembled and disassembled.

It is a further object of the present invention to promote a new and improved furniture joint which can be employed on many different types of furniture, like chairs, shelves, tables, dressers and beds.

It is a further object of the present invention to promote a new and improved furniture joint which provides a better and more reliable method to connect furniture parts.

It is a further object of the present invention to promote a new and improved furniture joint which provides an easy method to set-up and use, without the need of staples, nails or screws.

It is a further object of the present invention to promote a new and improved furniture joint which allows for seasonal movement of expanding and contracting wood across grain, even when joined with pieces of wood where the grain runs in a different direction.

It is a further object of the present invention to promote a new and improved furniture joint which creates a firm, tight, and reliable method to hold the furniture parts together.

An even further object of the present invention is to provide a new and improved furniture joint which is susceptible of a low cost of manufacture with regard to both materials and labor, and which accordingly is then susceptible of low prices of sale to the consuming public, thereby making such device economically available to the buying public.

Still yet another object of the present invention is to provide a new and improved furniture joint which provides in the apparatuses and methods of the prior art some of the advantages thereof, while simultaneously overcoming some of the disadvantages normally associated therewith.

These together with other objects of the invention, along with the various features of novelty which characterize the invention, are pointed out with particularity in the claims annexed to and forming a part of this disclosure. For a better understanding of the invention, its operating advantages and the specific objects attained by its use, reference should be had to accompanying drawings and descriptive matter which there is illustrated preferred embodiments of the invention.

### BRIEF DESCRIPTION OF THE DRAWINGS

The invention will be better understood based on the following detailed description. Such description makes reference to the annexed drawings wherein:

FIG. 1 shows a perspective view of the invention with the dowel.

FIG. 2 shows a perspective view of the invention without the dowel.

### DESCRIPTION OF THE PREFERRED EMBODIMENT

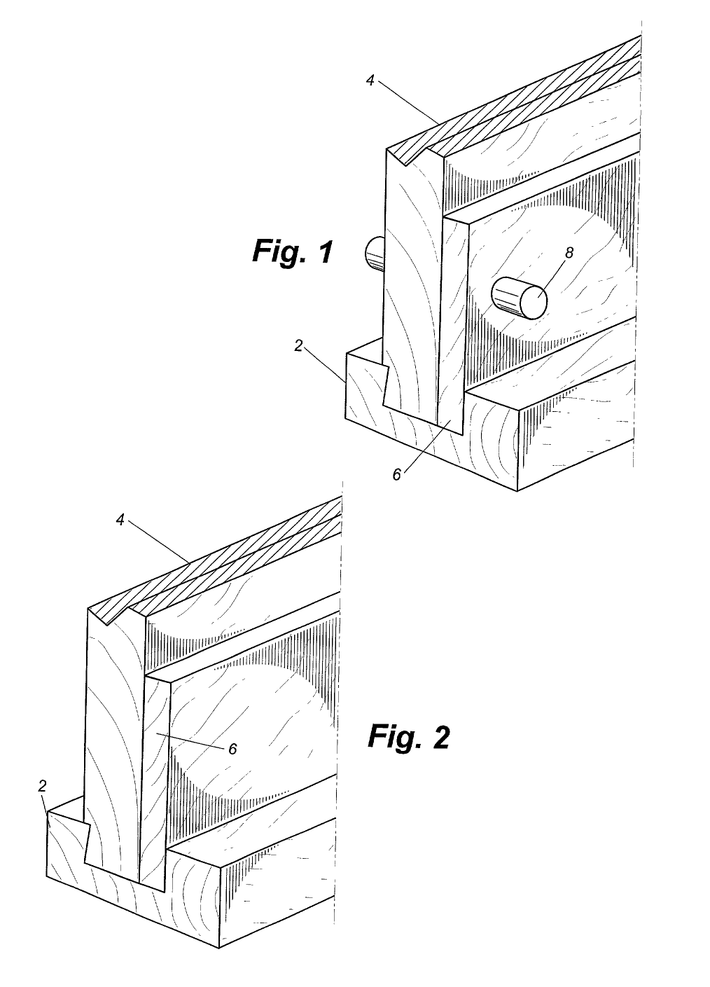

With reference now to the drawings, and in particular FIGS. 1 and 2, the furniture joint which embodies the principles and concepts of the present invention.

With reference to FIG. 1, FIG. 1 depicts a perspective view of an embodiment of the present invention which comprises a dowel 8 through a hole in the flat board 6 and a hole in the single sided dovetail board 4. This embodiment is assembled with a dowel 8 placed in a hole that is drilled in the single sided dovetail board 4 and the flat board 6. This embodiment provides a single sided dovetail board 4, a flat board 6, and a receiving furniture member 2; additionally, this embodiment fixer comprises a dowel 8.

The single sided dovetail board 4 has an angled edge on only one side (as opposed to a sliding dovetail joint that has an angled edge on both sides). The other side of the single sided dovetail board 4 is flat.

This embodiment of the furniture joint in FIG. 1 provides a receiving furniture member 2. The receiving furniture member 2 has a slot that has a corresponding angle, to that of the single sided dovetail board 4, in one portion of said slot of the receiving furniture member 2. The slot of the receiving furniture member 2 has a straight portion opposite said corresponding angle of said slot in the receiving furniture member 2. The angled edge of said single sided dovetail board 4 fits into the corresponding angle of the slot of the receiving furniture member 2. The single sided dovetail board 4 does not fill the entire slot of the receiving furniture member 2.

This embodiment of the furniture joint in FIG.1 provides a flat board 6. The flat board 6 is placed in the open area of the slot of the receiving furniture member 2. The flat board 6, along with the single sided dovetail board 4, fills the slot of the receiving furniture member 2. Once the slot of the receiving furniture member 2 is filled by the flat board 6 and the single sided dovetail board 4, the furniture joint of FIG.1 is assembled and the connection is firm. To insure an even stronger connection, a dowel 8 is placed in a hole that is drilled in the flat board 6 and a hole in the single sided dovetail board 4. So, that the dowel 8 fits within such holes.

With reference to FIG. 2, FIG. 2 depicts a perspective view of the preferred embodiment of the present invention. It provides a single sided dovetail board 4, a flat board 6, and a receiving furniture member 2. The single sided dovetail board 4 has an angled edge on only one side (as opposed to a sliding dovetail joint that has an angled edge on both sides). The other side of the single sided dovetail board 4 is flat.

The furniture joint of FIG. 2 also provides a receiving furniture member 2. The receiving furniture member has a slot that has a corresponding angle, to that of the single sided dovetail board 4, in one portion of said slot of the receiving furniture member 2. The slot of the receiving furniture member has a straight portion opposite said corresponding angle of said slot in the receiving furniture member 2. The angled edge of said single sided dovetail board 4 fits into the corresponding angle of the slot of the receiving furniture member 2. The single sided dovetail board 4 does not fill the entire slot of the receiving furniture member 2.

The furniture joint of FIG.2 provides a flat board 6. The flat board 6 is placed in the open area of the slot of the receiving furniture member 2. The flat board 6, along with the single sided dovetail board 4, fills the slot of the receiving furniture member 2. Once the slot of the receiving furniture member 2 is filled by the flat board 6 and the single sided dovetail board 4, the furniture joint of FIG. 2 is assembled and the connection is firm.

With respect to the above description then, it is to be realized that the optimum dimensional relationships for the invention to include variations in size, materials, shape, form, function and manner of operation, assembly and use, are deemed readily apparent and obvious to one skilled in the art, and all equivalent relationships to those skilled in the art, and all equivalent relationships to those illustrated in the drawings and described in the specification are intended to be encompassed by the present invention.

Thus, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

What is claimed as being new and desired to be protected by Letters Patent of the United States is as follows:

1. A furniture joint, comprising:
a flat board;
a single sided dovetail board having a flat surface and an angled surface;
a receiving furniture member having a slot in said receiving furniture member, said slot having an angled portion and a straight portion; and
said flat board and said single sided dovetail board being placed within said slot of said receiving furniture member.

2. The furniture joint of claim 1, further comprising a dowel wherein said flat board has a hole therein and said single sided dovetail board has a hole therein such that said dowel fits within said hole of said flat board and said hole of said single sided dovetail board.

3. The furniture joint of claim 1, wherein said angled surface of said single sided dovetail board is at least five degrees.

4. The furniture joint of claim 1, wherein said angled portion of said slot of said receiving furniture member is at least five degrees.

5. The furniture joint of claim 1, wherein said angled surface of said single sided dovetail board is no greater than twenty degrees.

6. The furniture joint of claim 1, wherein said angled portion of said slot of said receiving furniture member is no greater than twenty degrees.

7. The furniture joint of claim 1, wherein said angled surface of said single sided dovetail board and said angled portion of said slot of said receiving furniture member are substantially the same.

8. The furniture joint of claim 1, wherein said single sided dovetail board and said flat board fit substantially within said slot of said receiving furniture member.

9. A furniture joint, comprising:
a flat board having a hole therein;
a single sided dovetail board having a flat surface and an angled surface and a hole therein;
a receiving furniture member having a slot in said receiving furniture member, said slot having an angled portion and a straight portion;
a dowel;
said flat board and said single sided dovetail board being placed within said slot of said receiving furniture member; and
said dowel being placed within said hole of said flat board and said hole of said single sided dovetail board.

10. The furniture joint of claim 9, wherein said angled surface of said single sided dovetail board is at least five degrees.

11. The furniture joint of claim 9, wherein said angled portion of said slot of said receiving furniture member is at least five degrees.

12. The furniture joint of claim 9, wherein said angled surface of said single sided dovetail board is no greater than twenty degrees.

13. The furniture joint of claim 9, wherein said angled portion of said slot of said receiving furniture member is no greater than twenty degrees.

14. The furniture joint of claim 9, wherein said angled surface of said single sided dovetail board and said angled portion of said slot of said receiving furniture member are substantially the same.

15. The furniture joint of claim 9, wherein said single sided dovetail board and said flat board fit substantially within said slot of said receiving furniture member.

16. The furniture joint of claim 9, wherein said dowel fits snuggly within said hole of said single sided dovetail board and said hole of said flat board.
